(19) United States
(12) Patent Application Publication
(10) Pub. No.: US 2016/0258189 A1
(43) Pub. Date: Sep. 8, 2016

(54) Electronic Control for Lock Assembly and Conversion Method

(71) Applicant: George Frolov, Farmington, CT (US)

(72) Inventor: George Frolov, Farmington, CT (US)

(21) Appl. No.: 14/640,675

(22) Filed: Mar. 6, 2015

(51) Int. Cl. E05B 47/00; E05C 1/16; E05B 63/08

(52) U.S. Cl. CPC E05B 47/0001; E05B 63/08; E05C 1/16

(57) ABSTRACT

A conversion kit and conversion method employs an electronic module which is installed to the interior side of a door and interacts with a lockset to provide for an electronically controlled lockset. An electromechanical assembly which connects between the electronic module and the mortise lockset has a clutch. The clutch functions to mechanically allow free egress from the secured side of the door in the event that the latch bolt and the deadbolt are disposed in intermediate positions between the fully retracted unlocked positions and the fully projected locked positions due to power failure or other conditions.

### BACKGROUND

This disclosure relates generally to locks with or without a deadbolt. More particularly, this disclosure relates to providing electronic controls for mortise locks, interconnected locks and deadbolts.

Mechanical locks have enjoyed tremendous popularity and, over the years, have been provided in numerous configurations. One representative type of mechanical lock for which the electronic control and conversion method has particular applicability is a mortise lock. In a typical mortise lock of mechanical form, the locking and unlocking from outside is accomplished by a key cylinder. The key cylinder controls the latch bolt. For applications which also have a deadbolt, the key cylinder also simultaneously controls the deadbolt. For mechanical mortise locks, the locking and unlocking function from inside is accomplished by a deadbolt knob. When the deadbolt knob is rotated in one direction, the knob unlocks the outside lever to retract the latch bolt and the deadbolt. When the knob is rotated in the opposite direction, the outside lever is locked and the deadbolt is projected. The inside lever simultaneously retracts the deadbolt and the latch bolt.

Most existing electronic locks are principally based on restructuring the mechanical function of the mechanical mortise lock wherein the electrified mechanism essentially locks the outside lever. The electrified mechanism is located on the outside of the door, or may be located inside the lock case. The electrified mechanism, which is located on the outside, is vulnerable to vandalism. Typically, the electronic locks also eventually lose the ability to project the deadbolt which renders the deadbolt function as essentially a night latch. It is also possible for some embodiments that the deadbolt and the latch bolt can be jammed in an intermediate position between the projected locked and retracted unlocked positions upon a power failure.

Because there are numerous installed mechanical locks such as, for example, in classroom doors, it is highly desirable to provide a kit and method wherein existing mechanical locks can be easily converted to incorporate an electronic control for locking the door to entry from the exterior while also providing fail safe egress from the interior.

### SUMMARY

Briefly stated, an electrically controlled lockset, in one integrated embodiment, comprises a lockset with a deadbolt and a latch bolt. A first assembly comprises a first rotatable member rotatable between two positions defining a locked and an unlocked position of each of the deadbolt and the latch bolt. An inside lever mechanically connects the first assembly for simultaneously retracting the deadbolt and the latch bolt. A second assembly comprises a rotatable shaft which rotatably connects the shaft to the first rotatable member. A control module comprises a second member freely rotatable on the shaft. A clutch connects the second member to the shaft. An electronically controlled electromechanical assembly comprises a rotary drive wherein, at a rest position, the shaft is connected by the clutch to allow free rotation between locked and unlocked positions and is engageable with the second member at either a locked or unlocked position and upon receiving an electronic command, the second member and the shaft are rotated to respectively unlocked or locked positions and transform to the rest position.

The clutch is spring operated. The clutch comprises a torsion spring. The second member is an arm. The rotary drive preferably comprises an electric motor and a gear assembly which drives the shaft.

In another embodiment, the electronically controlled lockset comprises a lockset having only a latch bolt which has a locked and an unlocked position. A control module comprises a second member freely rotatable on the shaft and a clutch which connects the second member to the shaft. An electronically controlled electromechanical assembly comprises a rotary drive. At a rest position, the shaft is connected by the clutch which comprises a torsion spring to allow free rotation between the locked and locked positions. Upon receiving an electronic command, the electronically controlled electromechanical assembly rotates the second member and the shaft to an unlocked or a locked position. In some embodiments, the electromechanical assembly is responsive to signals transmitted from a wireless fob.

In one embodiment, a conversion module electronically controls the operation of a lockset and includes a wireless fob and a housing. A shaft is disposed in the housing. A thumb turn is mounted at one shaft end and an opposing shaft end projects from the housing. The second member is freely rotatable on the shaft. The clutch connects the second member to the shaft. An electronically controlled electromechanical assembly is responsive to signals transmitted from the fob. The assembly comprises a rotary drive wherein, at a rest position, the shaft is connected by the clutch to allow free rotation between locked and unlocked positions and is engageable with the second member at either locked unlocked position. Upon receiving an electronic command, the assembly rotates the second member and the shaft to an unlocked or locked position and transforms to the rest position. The clutch comprises a torsion spring.

### BRIEF DESCRIPTION OF THE DRAWINGS

FIG. 1 is a perspective view of a mortise lockset, including a deadbolt and a latch bolt, and an electronic module mounted to a door, partially illustrated and viewed from the inside thereof, together with a fob for operating the electronic module;

FIG. 2 is a perspective view of the mortise lockset and door of FIG. 1 as viewed from the outside thereof together with a fob;

FIG. 3 is a generally interior view of the mortise lockset of FIG. 1;

FIG. 4 is an interior view of a mortise lockset which incorporates only a latch bolt;

FIG. 5 is a fragmentary partially exploded perspective view of the mortise lockset of FIGS. 1 and 3;

FIG. 6 is a perspective view of an assembled electronic module;

FIG. 7 is a perspective view of the electronic module of FIG. 1 with an outer cover removed;

FIG. 8 is a perspective rear view of the electronic module of FIG. 6;

FIG. 9 is an enlarged fragmentary interior perspective view of the electronic module of FIG. 6;

FIG. 10 is an enlarged fragmentary interior perspective view of a back portion of the electronic module of FIG. 6;

FIG. 11 is an enlarged fragmentary interior perspective view, partially exploded, of a front portion of the electronic module of FIG. 6.

FIG. 12 is a fragmentary perspective exploded view of the electronic module of FIG. 6 further illustrating details of a clutch assembly;

FIG. 13 is a fragmentary interior exploded perspective view illustrating the clutch assembly;

FIG. 14 is a second fragmentary interior exploded perspective view of the clutch assembly of FIG. 13;

FIG. 15 is an enlarged fragmentary interior perspective view illustrating a clutch mechanism of the electronic module; and

FIG. 16 is a partially exploded perspective view of the electronic module.

### DETAILED DESCRIPTION

With reference to the drawings wherein like numerals represent like parts throughout the several figures, a universal conversion kit in the form of a door mounted electronic module is generally designated by the numeral 100. The electronic module 100 is adapted to interface with a mechanical lock which, for purposes of illustration, is a mortise lock 10 which, except for the modifications described herein, may be of conventional form and function.

The electronic module 100 upon installation functions to provide electronic locking control in terms of projecting the deadbolt and the latch bolt to the locked position from the interior side of the door while also allowing for immediate safe egress through the door to the exterior even though entry through the doorway from the exterior is initially precluded by the projected latch bolt and deadbolt.

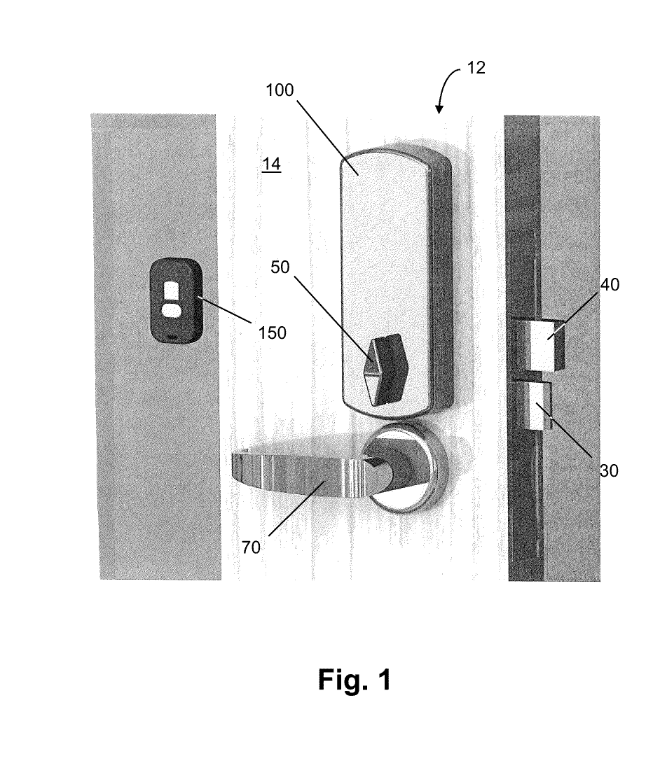

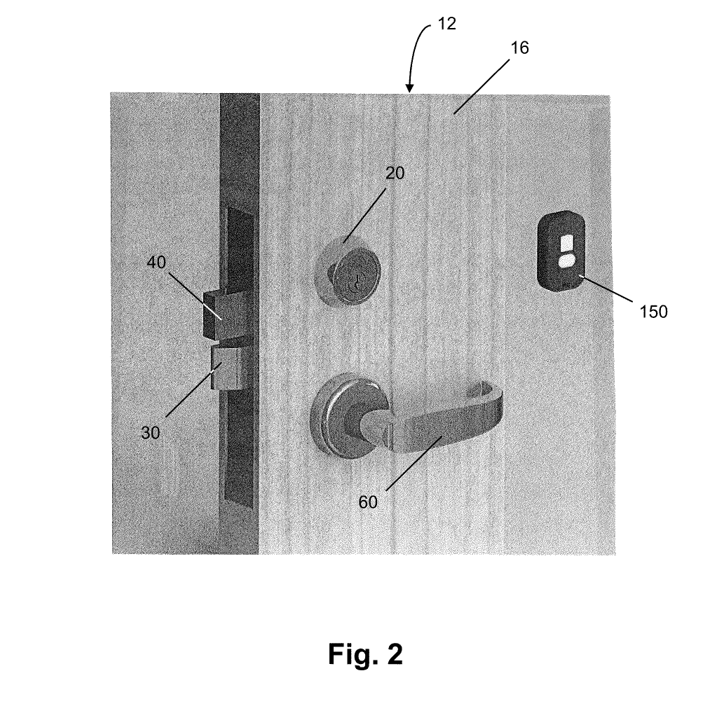

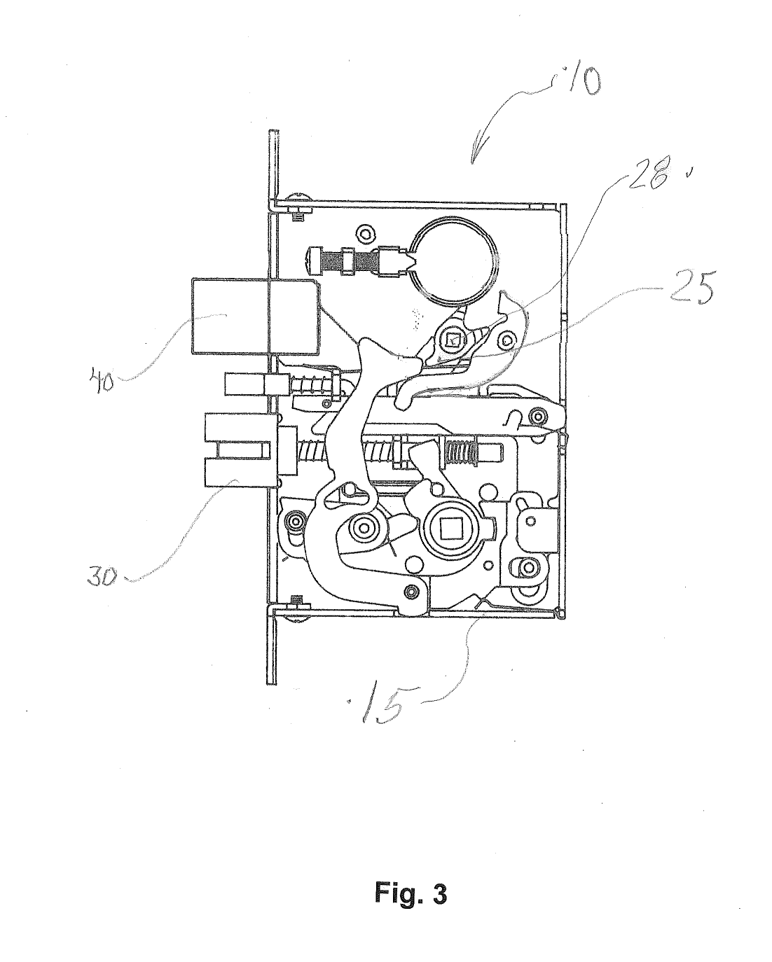

With reference to FIGS. 1 and 2, a representative installation is illustrated in conjunction with a door 12 having an interior side 14 and an exterior side 16. The locking and unlocking function of the mechanical mortise lockset 10 (FIG. 3) is typically accomplished from exteriorly of the door by the key cylinder 20. The key cylinder 20 controls the exterior latch bolt 30 and the deadbolt 40. The locking and unlocking function from interior of the door is typically accomplished by manual operation of the deadbolt knob or the thumb turn 50. When the deadbolt knob 50 is rotated in a first direction, the outside lever 60 is unlocked to allow manual retraction of the latch bolt 30 and retraction of the deadbolt 40. When rotated in the opposite direction, the deadbolt knob 50 locks the outside lever 60 and projects the deadbolt. Rotation of the inside lever 70 also retracts the deadbolt and the latch bolt simultaneously.

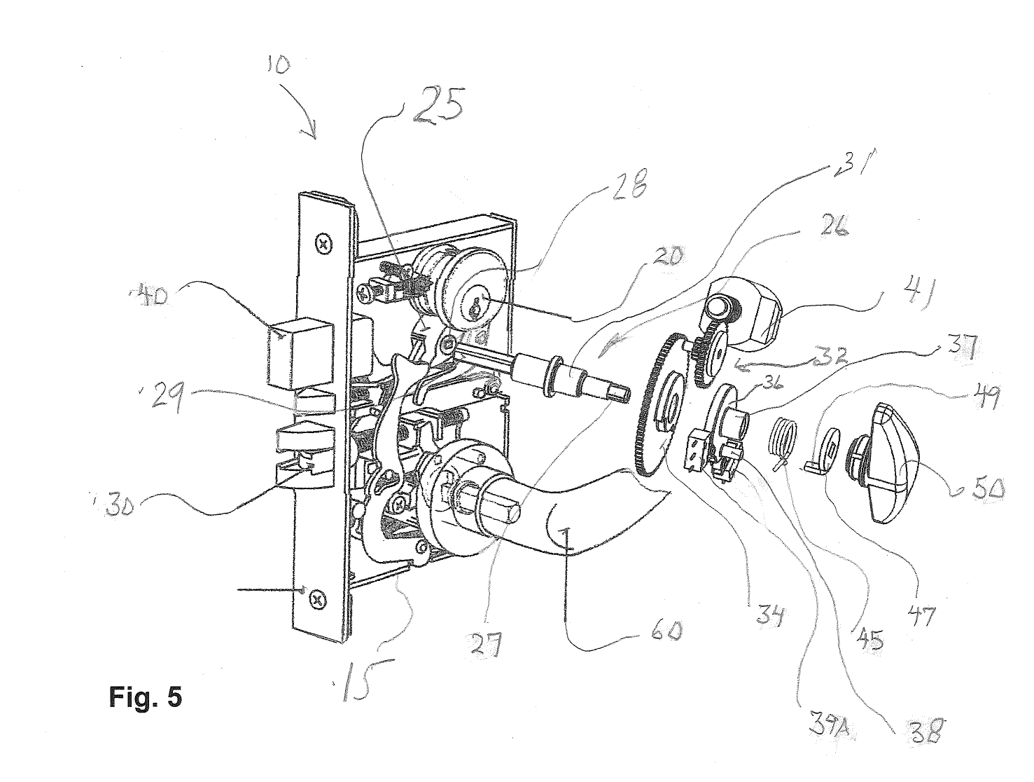

With reference to FIGS. 3 and 5, the representative mortise lockset 10 includes a case 15 which is furnished with the deadbolt 40, the latch bolt 30 and an internal rotary cam 25. The cam 25 has a limited angle of rotation of 90 degrees for conventional mortise locksets and stand-alone cylindrical deadbolts. The conventional deadbolts are typically supported in the extreme position by relatively weak springs which require overriding by other assemblies to move the bolts. The rotation is typically is limited by various internal structures built into the case 15. The stop positions are associated with the locked position wherein the deadbolt 40 is projected and the outside lever 60 is locked or the unlocked position wherein the deadbolt 40 is retracted. The cam 25 is rotated from inside by the thumb turn 50 attached to a spindle 26 inserted into a square opening 28 to lock or unlock, or by the inside lever 70 to only retract the deadbolt 40 and the latch bolt 30 simultaneously. From the exterior of the door, the cam 25 is rotated by the mechanical keyed cylinder 20 to lock or unlock the mortise lockset.

With additional reference to FIG. 5, electromechanical portions of the electronic module which are installed in connection with the mortise lockset 10 are illustrated in exploded form. The key cylinder 20, the inside lever 60 and the spindle 26 with a square end 29 functionally engage the rotary cam 25. A square end 27 at the opposite end of the spindle 26 engages the thumb turn 50.

A cylindrical middle portion 31 of the spindle 26 interacts with a geared power train 32 with a last gear 34 riding on the cylindrical middle portion 31. An electric motor 41 drives the power train 32. A cam 36 having a drive pin 38 also rides on the cylindrical middle portion 31 of the spindle. The cam has end switches 39A and 39B. A preloaded torsion spring 45 has ends which embrace the drive pin 38 on the cam 36. A drive washer 47 having a flat return 49 is mounted to the square end 27 of the spindle.

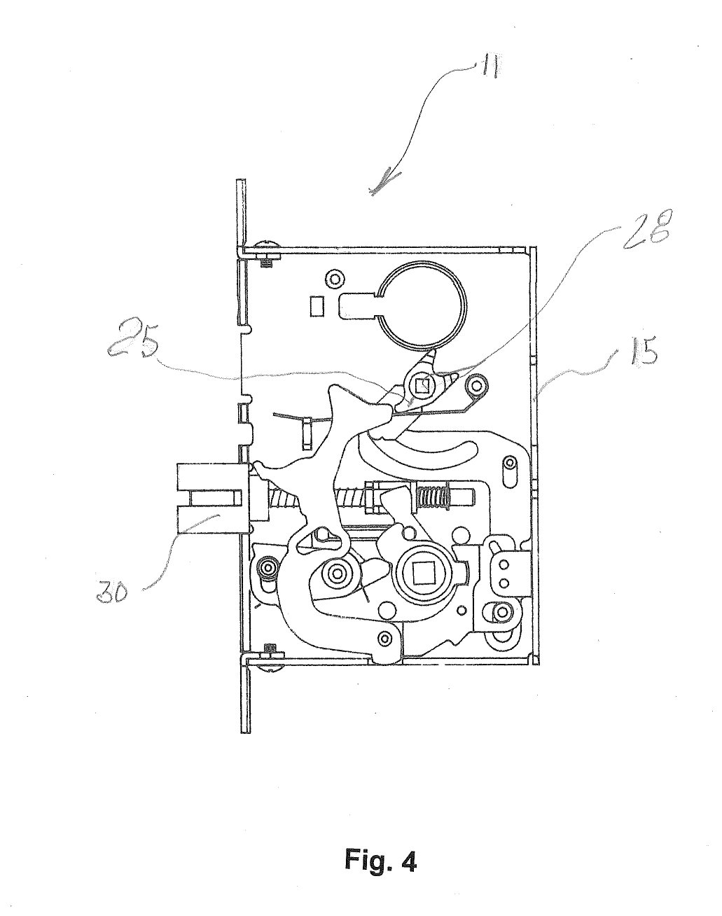

FIG. 4 illustrates a mortise lockset 11 having a latch bolt 30 and without the deadbolt. The other components are substantially the same as in FIGS. 3 and 5. The cam 25 only locks or unlocks the outside lever with the same 90 degree rotation.

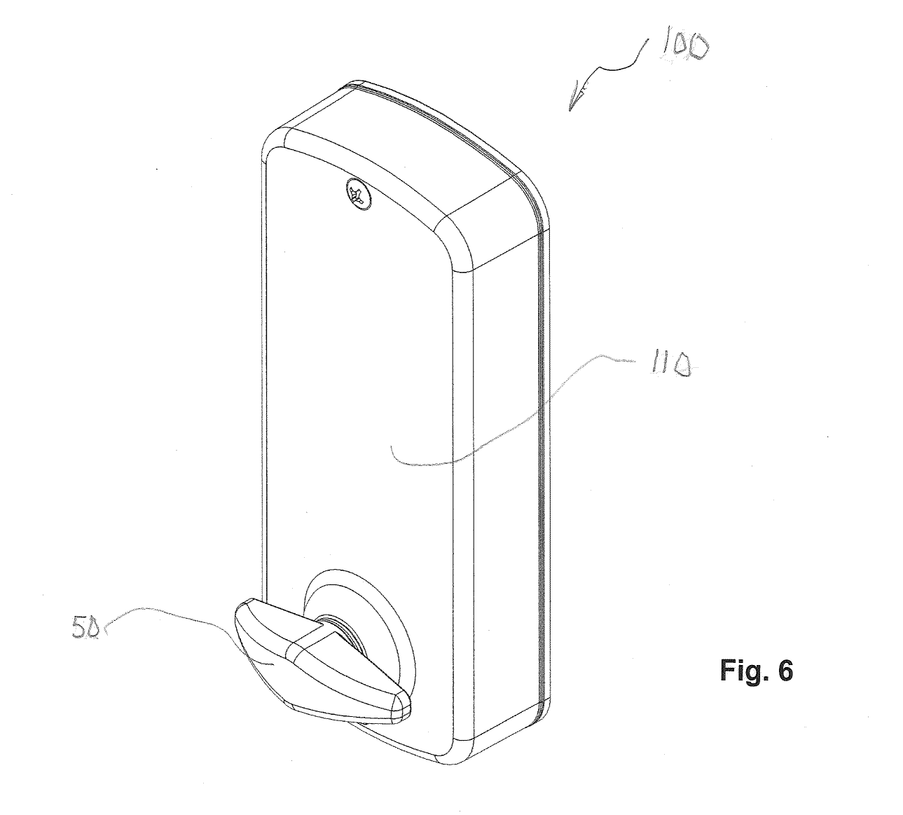

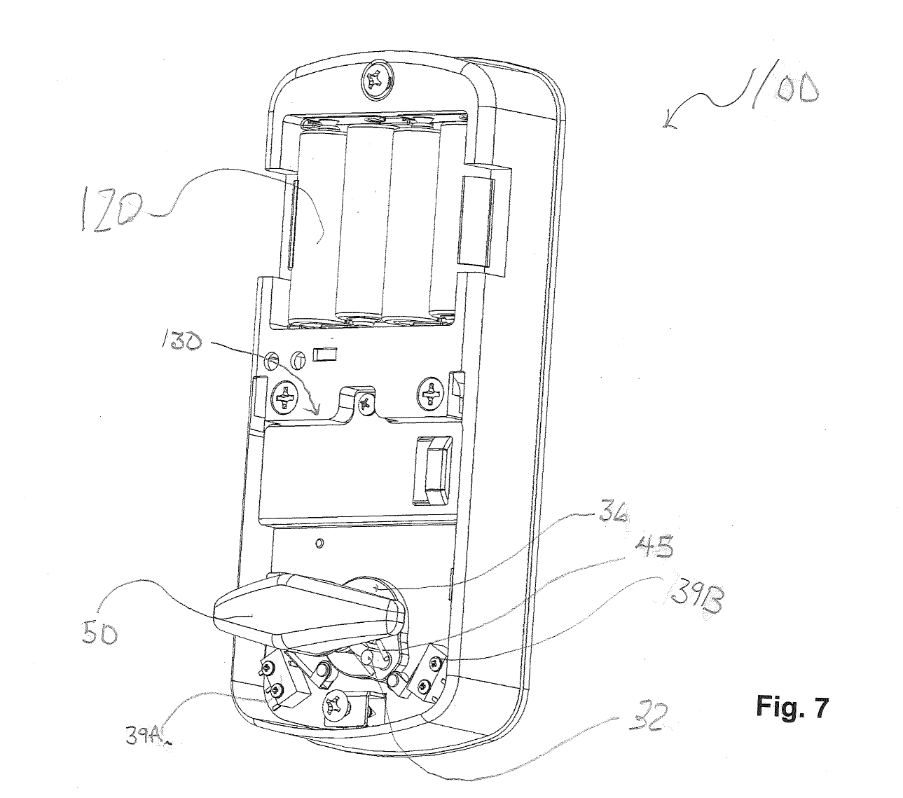

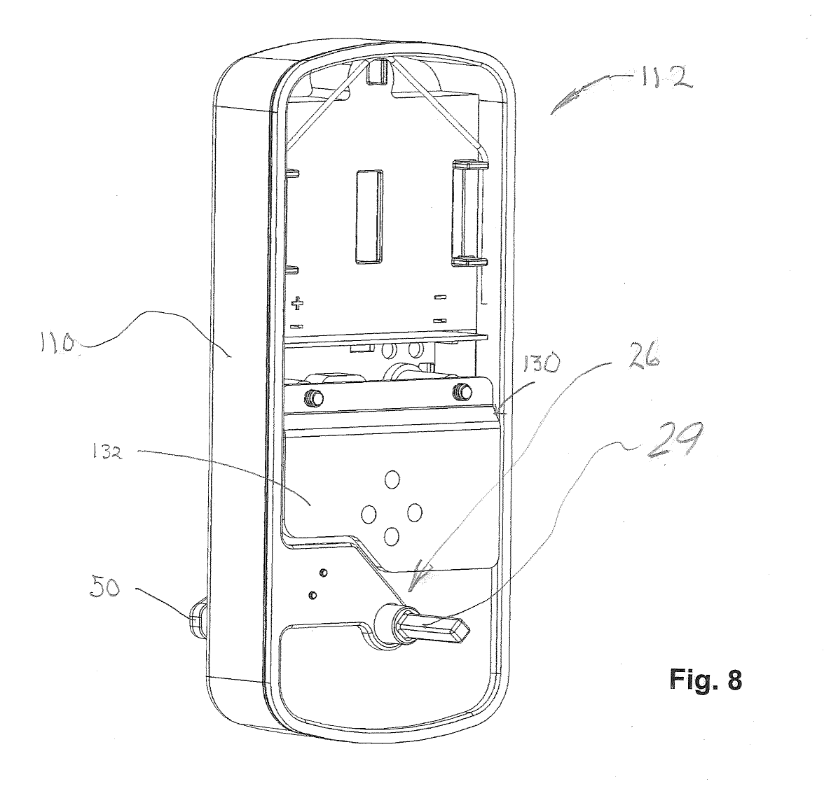

With reference to FIGS. 6 through 8, the electronic module 100 includes a front cover 110 and mounts the thumb turn 50. A power supply 120 includes batteries for powering the unit and operating the lockset as will be further described. In this embodiment, wireless commands are transmitted to a controller 130 (behind plate 132) of the module by a fob 150. Magnetic cards, keypads, etc., may also be employed. The module houses mechanical components of and which connect with the lockset 10. The cam 36 is illustrated depressing one of the end switches 39B. The back 112 of the electronic module shows the spindle 26 with the square end 29 exposed.

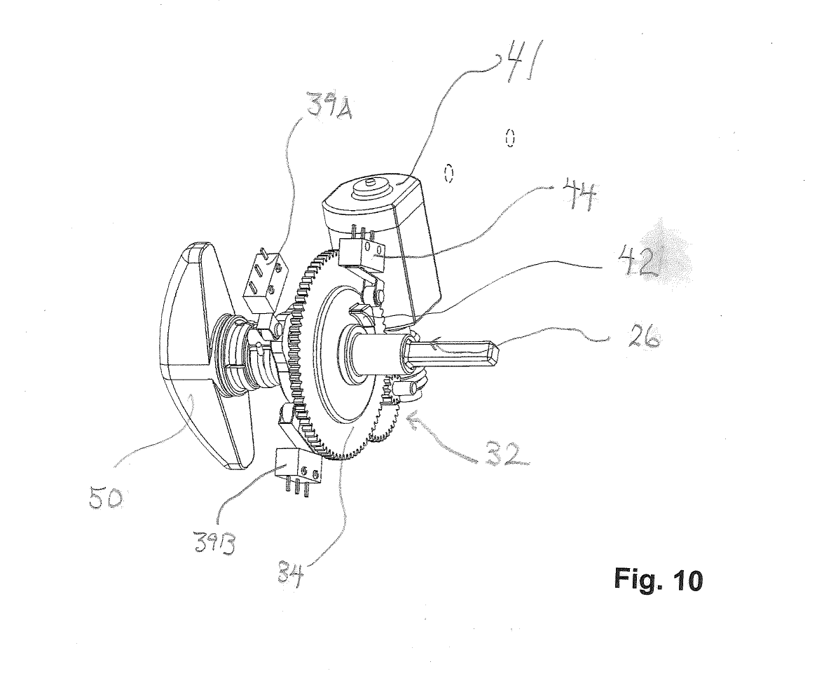

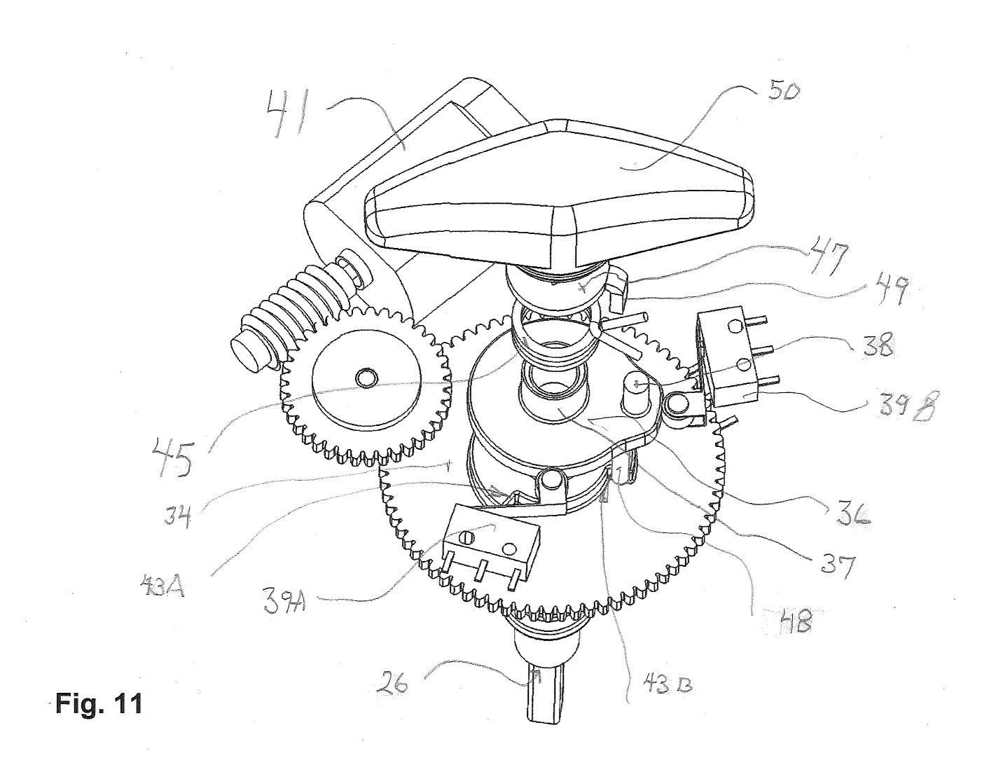

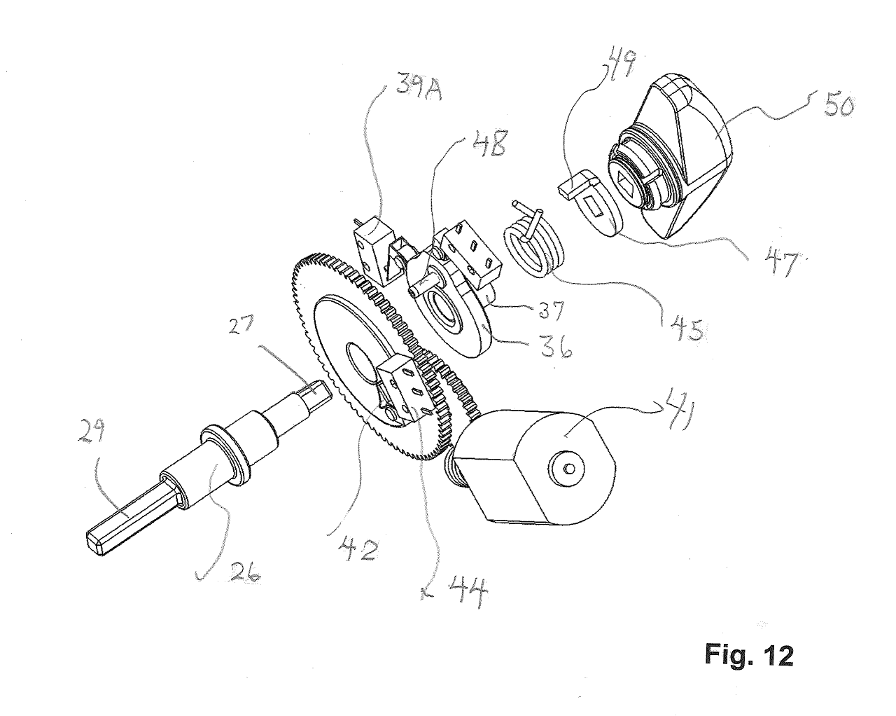

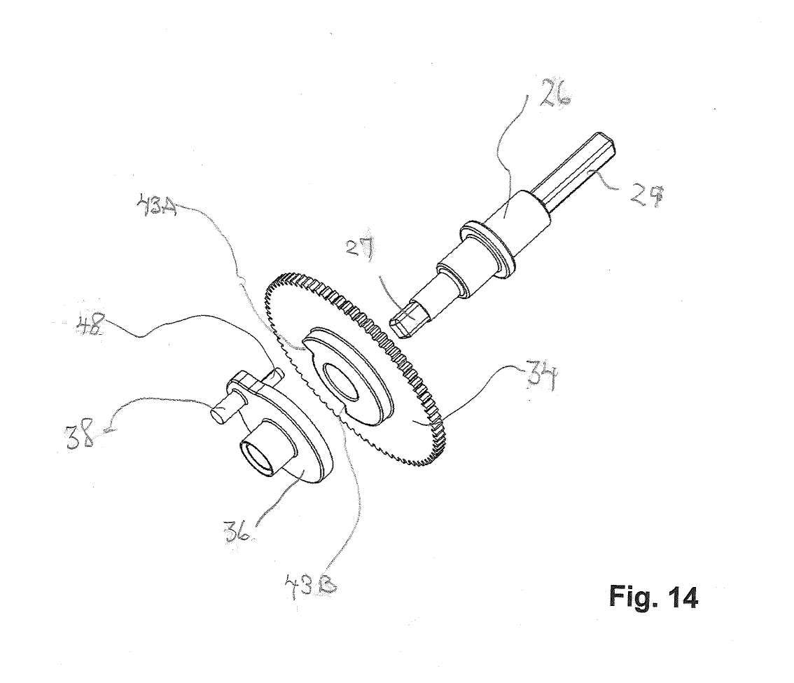

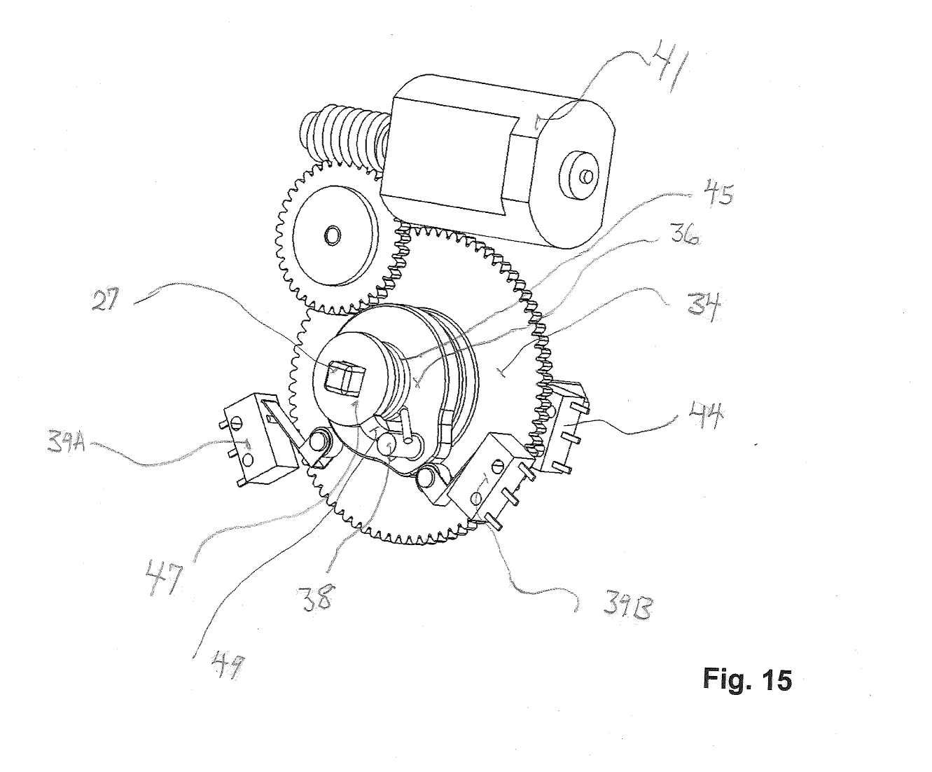

As best illustrated in FIGS. 10, a gear cam 42 of the power train 32 depresses a switch 44 in a resting position. The switch 44 waits for a command from the controller 130 to lock or unlock the lockset. The power train gear 34 has an accurate recessed structure about the central axis of the spindle which is defined by two angularly spaced flat surfaces 43A and 43B. A cam 42 built into the gear 34 of the gear train is shown depressing the end switch 39B in FIG. 10. Another axially extending drive pin 48 projects from the cam 36 and is best illustrated in FIG. 11. The pin 48 could be pushed clockwise or counter clockwise by the two ninety degrees angularly spaced flat surfaces 43A and 43B defined on the gear 42. The foregoing components and their structures and interrelationships from various perspectives are illustrated in FIGS. 12 through 15.

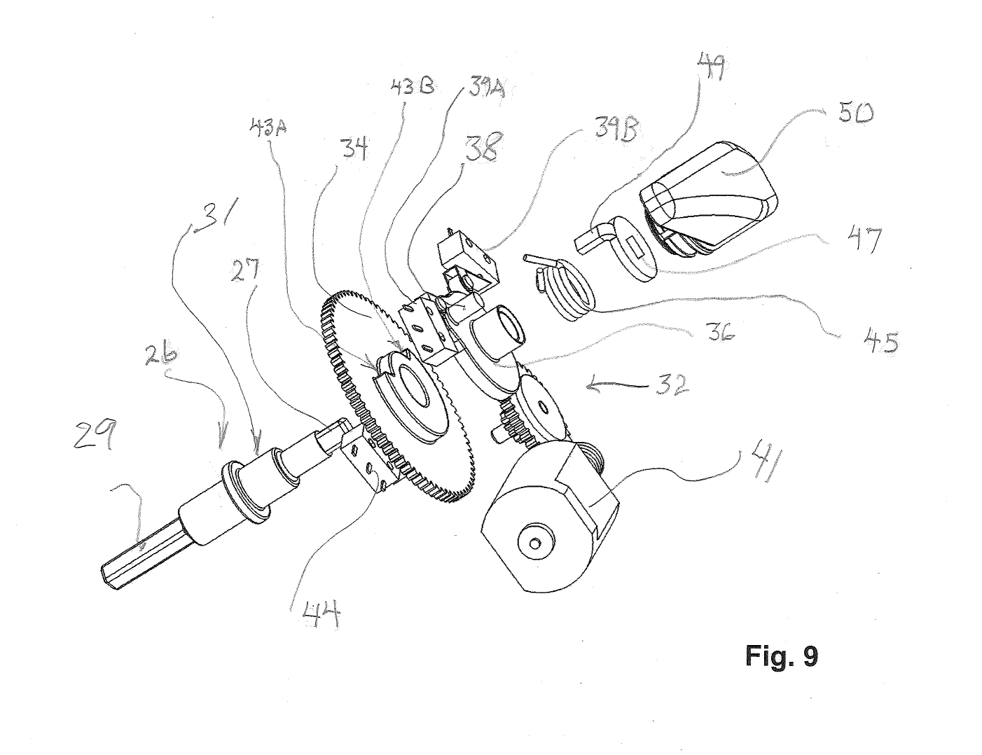

In a representative normal static position, best shown in FIG. 10, wherein the lock could be locked or unlocked, the last gear of the power train 32 is resting in a positon such that the cam 36 is depressing the switch 44, interrupting power to the motor 41. The flats 43A and 43B, built into gear 42 in FIG. 9 are symmetrically located relative to the vertical center line and angularly spaced 90 degrees apart. The end switches 39A and 39B shown in FIGS. 5, 7, 9 and 15 are mounted to fixed relationship to the housing or frame, and also are located symmetrically relative to the vertical center line and angularly spaced 90 degrees. Under normal operational conditions, the cam 36, rotatable on the cylindrical portion 31 of the spindle 26 is resting with its drive pin 48 against one of the two flats 43A or 43B simultaneously depressing one of the end switches 39A or 39B.

The switches 39A and 39B indicate the locked or unlocked position and define the direction of the gear 34 rotation upon a command received from the controller. The command would also override the switch 44. The flat 43B in FIG. 11 would drag the cam 36 via drive pin 48 until it hits the switch 39A, which would, in turn, generate a command to reverse rotation of the gear 34. The gear 34 would go back until hitting the switch 39B by the cam 36. Now in this new position, the pin 48 would be left against the flat 43A ready for the next command.

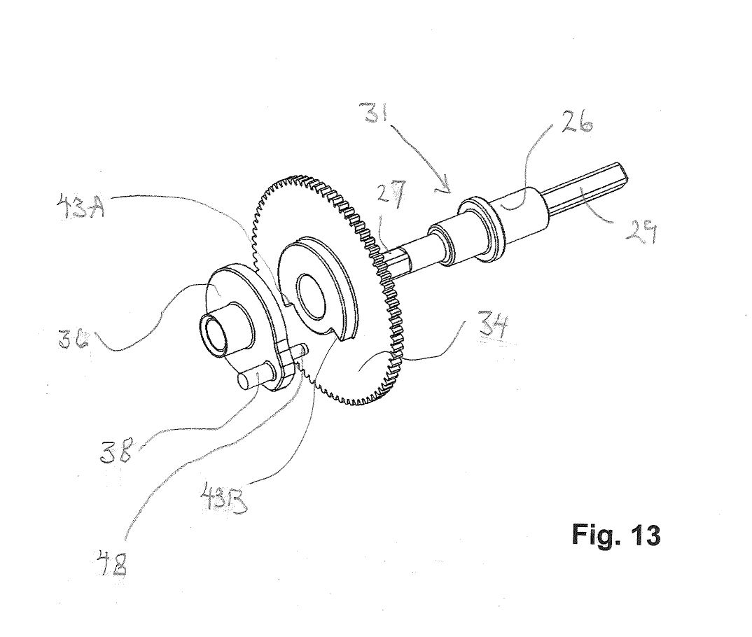

Rotatable cam 36 carries over its hub 37 the torsion spring 45 preloaded over drive pin 38 fixedly attached to the cam. Next to the spring 45, but on the square portion 27 of the spindle 26 (in FIG. 13) sits the washer 47 with the flat return 49, also embraced by preloaded ends of the torsion spring 45. This arrangement kinematically connects between the cam 36 and the spindle 26 (see FIGS. 5 and 9) and ultimately with the thumb turn 50 and the rotary cam 25 (FIGS. 3 and 5).

It is easy to see that between the electronic commands, the thumb turn 50 and the mechanical key 20 would manually operate the deadbolt between the end stops, internally and externally of the door without any resistance provided that there no any external obstructions in the deadbolt path. The manual operation is also flawlessly coordinated with the electrical operation.

A conventional electronically controlled lockset of types mentioned would typically perform flawlessly mechanically even if the electronics or the power train would fail, but only at the fully locked or fully unlocked deadbolt positions. However, catastrophic electronic or mechanical failures, which would occur at the partially projected deadbolt positions could lead to a completely unsafe situation, wherein the manual operator would not be able to lock a door completely if the failure occurs while the deadbolt is being moved from the projected to the retracted positions. An even worse situation would potentially occur if failure happens while the bolt is being moved from the retracted positon to the projected position. A manual operator would not be able to unlock the door by any means from either side of the door.

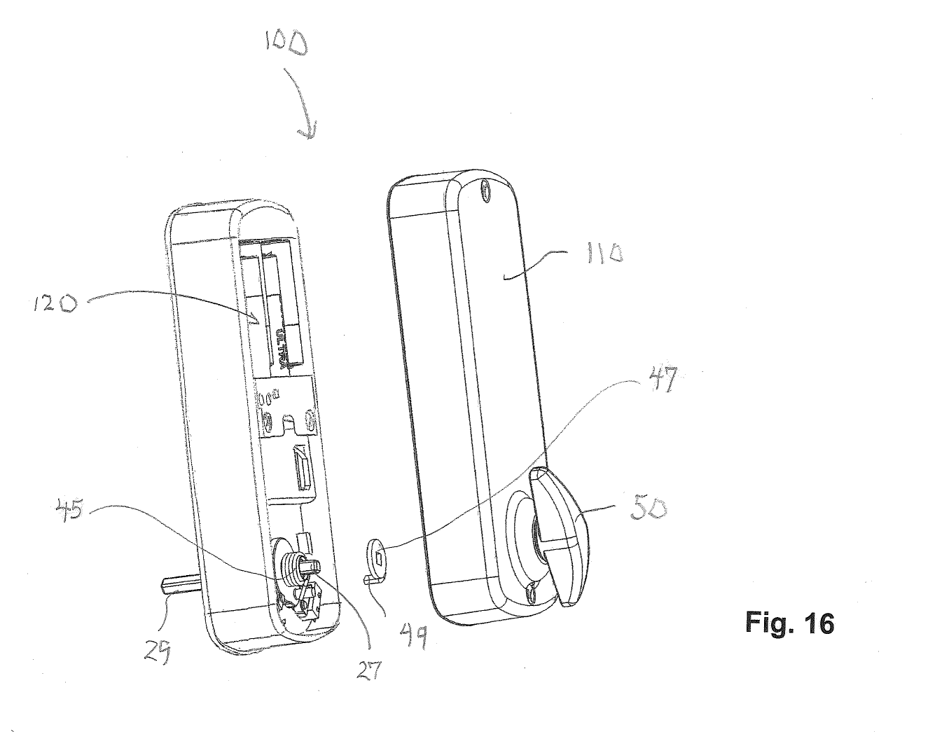

By contrast, implementation of the clutch assembly comprising the torsion spring 45 allows manual operation in the first situation and escape from a potentially deadly second situation. For the manual operation, the mechanical key 20 (outside) and the thumb turn 50 (inside) would be able to overpower the torsion spring 45 and unlock the door and transfer the operation from electromechanical to a pure mechanical operation. FIG. 16 illustrates how the installation could be done from the inside. The inside cover 110 is dismounted, the drive washer 45 is removed, and the cover remounted.

The present invention accommodates numerous potentially hazardous situations, namely, handling inability to predict in what positon a manual operator may leave the deadbolt. From numerous figures one can see, that normal bolt positons—locked or unlocked—are those recorded by the end switches 39A and 39B and the switch 44. When neither end switch 39A nor 39B is depressed, the controller would be designed to automatically rotate the cam 36 in one of the two predetermined positions: locked (could be called “fail secure”) or unlocked (could be called “fail safe”).

While preferred embodiments have been set forth for purposes of illustration, the foregoing description should not be considered a limitation of the invention herein. Accordingly, various modifications, adaptations and alternatives may be provided without departing from the spirt and scope of the present invention.

1. An electronically controlled lockset comprising:
a lockset comprising:
a deadbolt;
a latch bolt;
a first assembly comprising of first rotatable member rotatable between two positions defining a locked and an unlocked position of each of said deadbolt and said latch bolt;
an inside lever mechanically connecting said first assembly for simultaneously retracting said deadbolt and said latch bolt;
a second assembly comprising a rotatable shaft and rotatably connecting said shaft to said first rotatable member; and
a control module comprising:
a second member freely rotatable on said shaft;
a clutch comprising a torsion spring and connecting said second member to said shaft;
an electronically controlled electromechanical assembly comprising a rotary drive wherein at a rest position, said shaft is connected by said clutch to allow free rotation between said locked and unlocked positions and is engageable with said second member at either a locked or unlocked position and, upon receiving an electronic command, rotating said second member and said shaft to said respectively unlocked or locked position and transform to the rest position.

2. The electronically controlled lockset of claim 1 where said second member is an arm.

3. The electronically controlled lockset of claim 1 wherein the rotary drive comprises an electric motor and a gear assembly which drives said shaft.

4. An electronically controlled lockset comprising:
a lockset comprising:
a latch bolt;
a first assembly comprising of first rotatable member rotatable between two positions defining a locked and an unlocked position of said latch bolt;
an inside lever mechanically connecting said first assembly for retracting said latch bolt;
a second assembly comprising a rotatable shaft and rotatably connecting said shaft to said first rotatable member; and
a control module comprising:
a wireless fob;
a second member freely rotatable on said shaft;
a clutch connecting said second member to said shaft, said clutch comprising a torsion spring;
an electronically controlled electromechanical assembly responsive to signals transmitted from said fob comprising a rotary drive wherein, at a rest position, said shaft is connected by said clutch to allow free rotation between said locked and unlocked positions and is engageable with said second member at either a locked or unlocked position and, upon receiving an electronic command, said second member and said shaft are rotatable to said respectively unlocked or locked position and transform to the rest position.

5. The electronically controlled lockset of claim 4 where said second member is an arm.

6. The electronically controlled lockset of claim 4 wherein the rotary drive comprises an electronic motor and a gear assembly which drives said shaft.

7. A conversion module for electronically controlling the operation of a lockset comprising:
an input device;
a shaft disposed in said housing and a thumb turn mounted at one shaft end and an opposing shaft end projects from the housing;
a second member freely rotatable on said shaft;
a clutch comprising a torsion spring and connecting said second member to said shaft;
an electronically controlled electromechanical assembly responsive to signals transmitted from said input device, said assembly comprising a rotary drive wherein, at a rest position, said shaft is connected by said clutch to allow free rotation between locked and unlocked positions and is engageable with said second member at either a locked or unlocked position and, upon receiving an electronic command, said second member and said shaft are rotatable to said respectively unlocked or locked position and transform to the rest position.

8. The conversion module of claim 7 where said second member is an arm.

9. The conversion module 7 wherein the rotary drive comprises an electronic motor and a gear assembly which drives said shaft.

10. The conversion module 7 wherein the input device is a wireless fob.

11. A method for converting a mechanical lockset mounted to a door and having a rotatable shaft with an operator which rotates said shaft for retracting a locking member to an electronically controlled lockset comprising:
providing an electronic module transformable between an unlocked position and a locked position and having a clutch assembly comprising a torsion spring;
mounting said electronic module to a secured side of the door;
operatively connecting said clutch assembly with the shaft of the lockset,
wherein said locking member is transformable between a retracted unlocked position and a projected locked position by said electronic module, and said operator is manually rotatable to mechanically retract said locking member to an unlocked position when said locking member is disposed between said unlocked and locked positions.
